(19) United States
(12) Patent Application Publication
(10) Pub. No.: US 2008/0067208 A1
(43) Pub. Date: Mar. 20, 2008

(54) Removable tray for a mobile apparatus

(75) Inventor: Katie Lynn Dinslage, Farmington, MN (US)

Correspondence Address: OPPENHEIMER WOLFF & DONNELLY LLP, 45 SOUTH SEVENTH STREET, SUITE 3300, MINNEAPOLIS, MN, 55402, US

(73) Assignee: Carry You LLC, Farmington, MN (US)

(21) Appl. No.: 11/521,189

(22) Filed: Sep. 14, 2006

(51) Int. Cl. B60R 7/00

(52) U.S. Cl. 224/409

(57) ABSTRACT

A removable tray for a mobile apparatus is provided. The removable tray includes two opposing longitudinal sides, first and second ends secured to opposite ends of the longitudinal sides, a bottom including longitudinal surfaces operably connected to lower edges of the longitudinal sides and end surfaces operably connected to first and second ends, and a fastening mechanism attached to an upper edge of one of the longitudinal sides and configured to accommodate attachment of the removable tray to a mobile apparatus. Alternately, the removable tray includes a continuous piece of a soft material configured to include two opposing longitudinal sides and a bottom; first and second ends operably attached to opposite ends of the longitudinal sides; and a fastening mechanism operably attached to an upper edge of one of the longitudinal sides and configured to accommodate attachment of the removable tray to a mobile apparatus.

### BACKGROUND OF THE INVENTION

The present invention relates to a removable tray. Specifically, this invention relates to a tray that is removably attached to a mobile apparatus.

While pushing or transporting their children in strollers or other mobile apparatus, parents and caregivers often find it convenient to provide food, beverages, toys and the like for their children. Several existing mobile apparatus, such as strollers, car seats, bike seats, and the like, are not equipped with trays attachable to a portion of the stroller that is accessible to a child or children being transported therein. There exists a need for a removable tray that can be easily attached to and detached from various mobile apparatus.

Much of the existing technology pertaining to snack trays includes permanently attached trays that are attached to a front of the stroller. These trays are not removable for use with a variety of strollers or other mobile apparatus. They are also not removable for use in various locations on a single mobile apparatus. There exists a need for a removable tray that can be used with a number of different mobile apparatus and/or in different locations on a single mobile apparatus.

The existing technology pertaining to snack trays is also directed to relatively flat snack trays constructed of a relatively hard material. These trays provide little support for food and drink containers that are relatively tall. Children being transported in mobile apparatus with these types of trays can bump their faces, mouths, etc. on the hard edge of the snack tray thereby potentially causing injury to the child. In addition, because these trays are permanently affixed to the mobile apparatus, they cannot be removed for cleaning. There exists a need for a removable tray that can provide support for tall food and drink containers, reduce potential injury to children being transported in the mobile apparatus and be removed for in-depth cleaning.

### SUMMARY OF THE INVENTION

The present invention addresses the above-mentioned needs by providing a removable tray constructed of a soft material and having holders and various sized pockets therewithin. The removable tray in accordance with the present invention can be easily attached to and detached from various mobile apparatus. The removable tray in accordance with one embodiment of the present invention includes two opposing longitudinal sides; first and second ends secured to opposite ends of the longitudinal sides; a bottom comprising longitudinal surfaces operably connected to lower edges of the longitudinal sides and end surfaces operably connected to first and second ends; and a fastening mechanism operably attached to an upper edge of one of the longitudinal sides and configured to accommodate attachment of the removable tray to a mobile apparatus.

In another embodiment, the removable tray in accordance with the present invention includes a continuous piece of a soft material configured to include two opposing longitudinal sides and a bottom; first and second ends operably attached to opposite ends of the longitudinal sides; and a fastening mechanism operably attached to an upper edge of one of the longitudinal sides and configured to accommodate attachment of the removable tray to a mobile apparatus.

The invention will be further described with reference to the following detailed description taken in conjunction with the drawings.

### BRIEF DESCRIPTION OF THE DRAWINGS

FIG. 1 is a front view of a removable tray in accordance with the present invention.

FIG. 2 is a side perspective view of one embodiment of the removable tray in accordance with the present invention.

FIG. 3 is a back view of one embodiment of the removable tray in accordance with the present invention where a fastening mechanism is in an unfolded or unattached position.

FIG. 4 is back view of the embodiment depicted in FIG. 3 with the fastening mechanism in a folded or attached position.

FIG. 5 is a perspective side view of the removable tray of the present invention.

FIG. 6 is a front perspective view of the removable tray of the present invention having container holders mounted on the exterior of the removable tray.

FIG. 7 is a front perspective view of the removable tray of the present invention having container holders mounted on the interior of the removable tray.

FIG. 8 is front perspective view of the removable tray of the present invention including a partial lid, a removable insert and a divider.

### DETAILED DESCRIPTION OF THE INVENTION

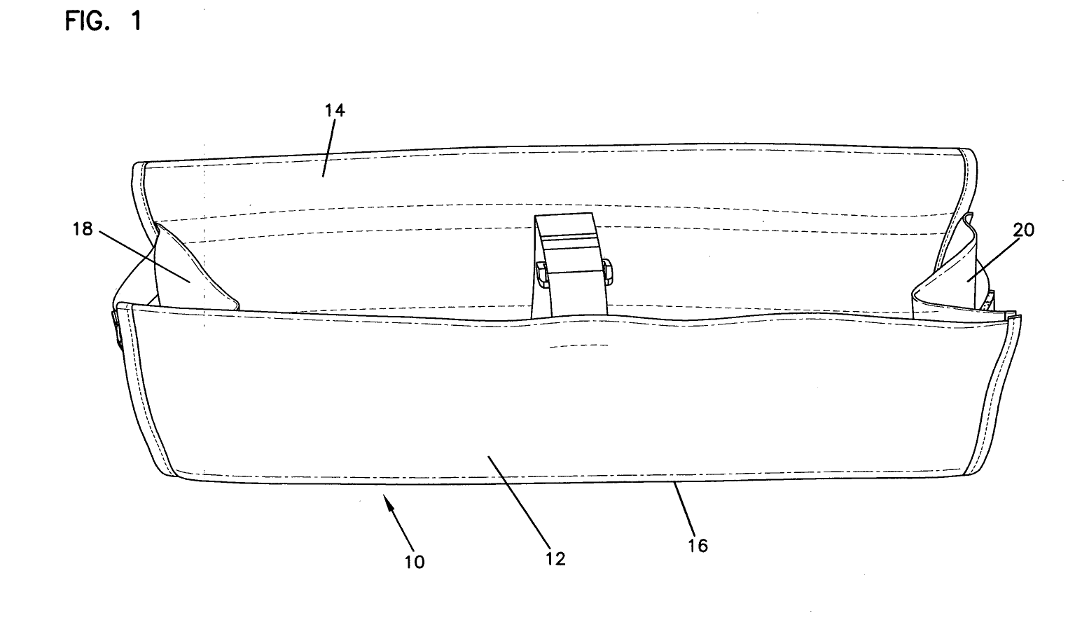

Referring now to FIG. 1 there is shown a removable tray 10 having two longitudinal sides 12, 14 integrally formed with a bottom 16. Removable tray 10 further includes two ends 18, 20 that are operably attached to two longitudinal sides 12, 14 and bottom 16 in order to form a storage compartment 22 therewithin. Removable tray 10 is generally constructed of a soft material, such as woven nylon pack material.

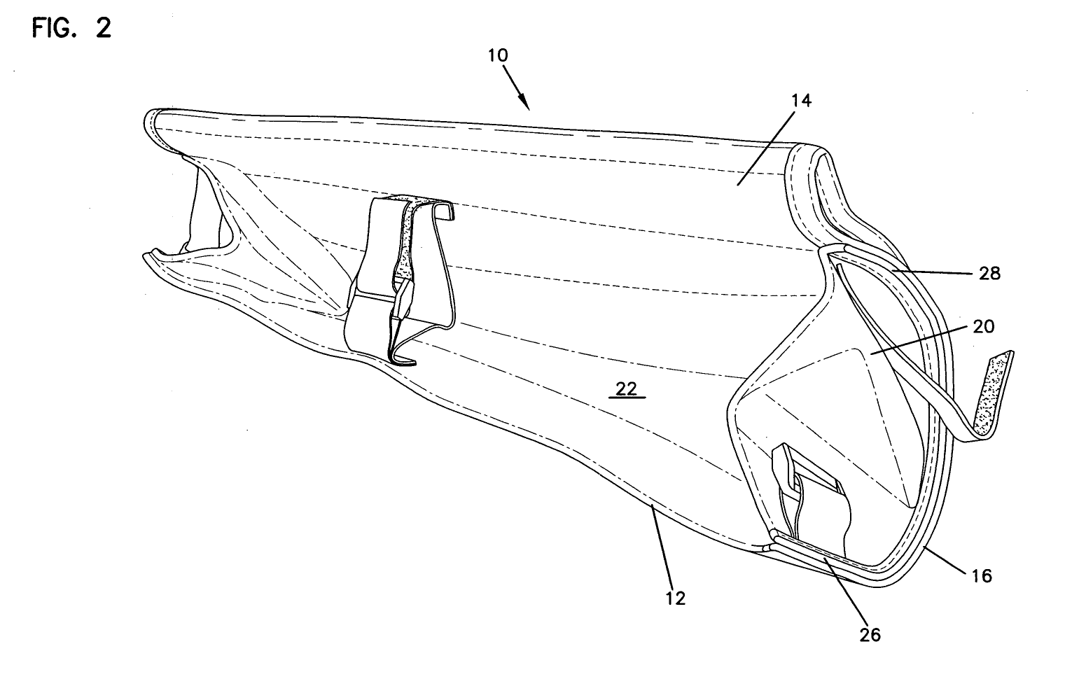

Referring now to FIG. 2, one embodiment of a removable tray 10 in accordance with the present invention includes first longitudinal side 12, second longitudinal side 16 and bottom 16 constructed of a continuous piece of material such that they create a substantially U-shaped storage compartment 22. Those skilled in the art can appreciate that first longitudinal side 12, second longitudinal side 14 and bottom 16 can be separate pieces of material that are attached to one another via known fastening techniques, including but not limited to sowing, zipping, snapping, Velcro attaching, and the like. Those skilled in the art can also appreciate that first longitudinal side 12, second longitudinal side 14 and bottom 16 can be attached to one another to form various shapes for the storage compartment 22 therewithin.

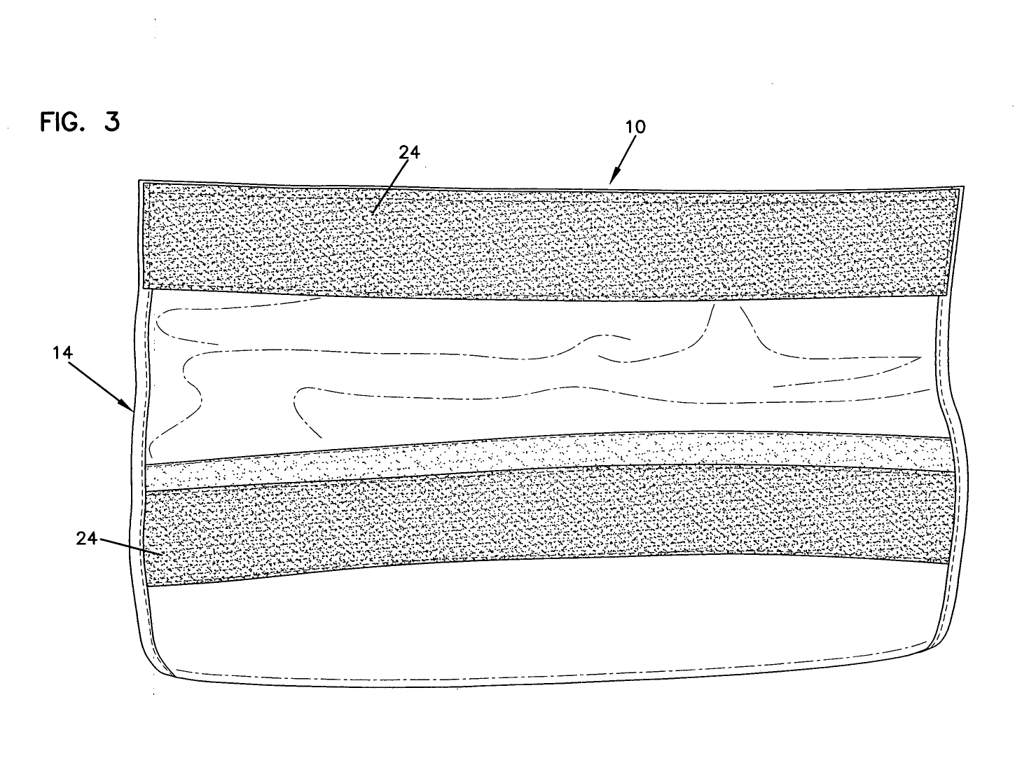

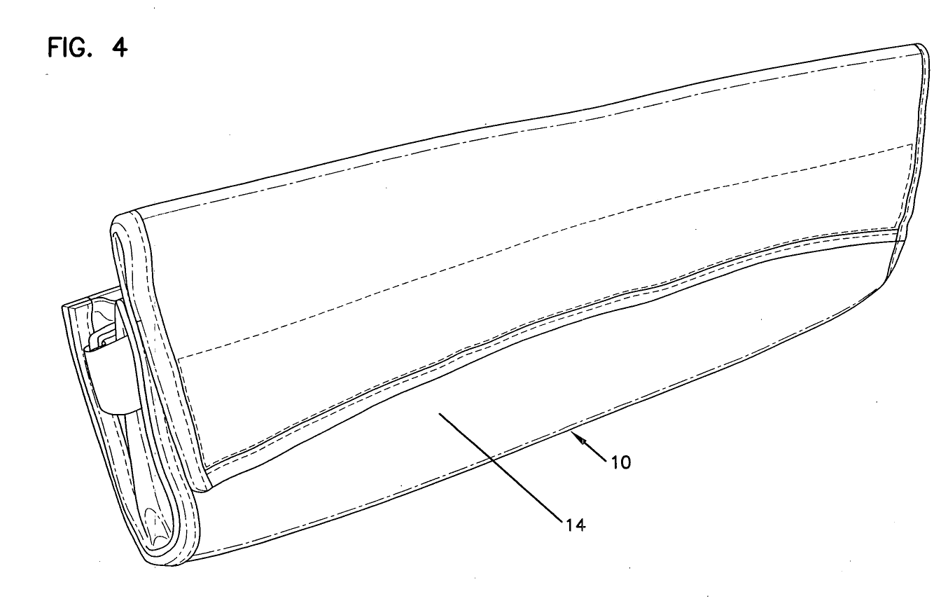

Referring still to FIGS. 1 and 2 are storage compartment 22 is sized to hold and support a wide variety of different shaped cups, bottles, glasses and other drinking containers, toys and the like. In one embodiment, first and second longitudinal sides 12, 14 range in size from about 8 inches wide by to about 16 inches wide and about 2 inches high to about 10 inches high. In this embodiment, second longitudinal side 14 is twice as high as first longitudinal side 12 and includes a fastening mechanism 24 as depicted in FIG. 3. Fastening mechanism 24 is used to removably attach removable tray 10 to a bar on a mobile apparatus. FIG. 3 shows compatible strips of Velcro material as fastening mechanism 24. Second longitudinal side 14 can be unfolded to expose fastening mechanism 24, removable tray 10 aligned with a support on a mobile apparatus, such as a bar, and second longitudinal side 14 folded over the support (as depicted in FIG. 4) such that fastening mechanism can be fastened around the support. Those skilled in the art can appreciate that various types of fastening mechanisms can be used to attach removable tray 10 to the mobile apparatus. Fastening mechanisms 24 include, but are not limited to, ties, snaps, zipper, hook and eye fasteners, buttons and the like. Those skilled in the art can also appreciate those fastening mechanisms 24 can be selected depending on the portion of the mobile apparatus to which removable tray 10 is being attached. In another embodiment, removable tray 10 can also include a support (not shown), which can be attached to mobile apparatus that are not equipped with a bar or other such device for supporting removable tray 10.

Again referring to FIG. 2, first end 18 and second end 20 are generally the same size and are positioned at opposing ends of first and second longitudinal sides 12, 14. In one embodiment, first and second ends 18, 20 are generally arcuate with two opposing sides 26 and 28 that are approximately 2 to 4 inches long. First and second ends 18, 20 are approximately 2 to 4 inches from a flat side to the mid-point of the arcuate side. In another embodiment, first and second ends 18, 20 are a different shape, such as rectangular, square, etc., having dimensions of generally 2 to 4 inches by 2 to 4 inches.

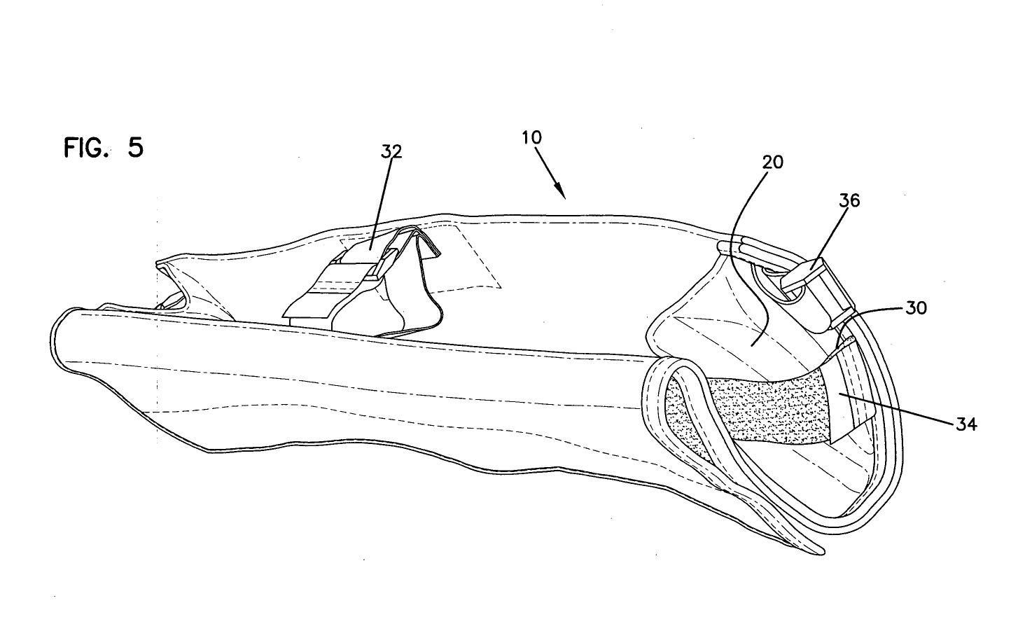

Referring now to FIG. 5, there is shown one embodiment of removable tray 10 having a plurality of width adjusters 30, 32 spaced longitudinally along the length of removable tray 10. In this embodiment, a first width adjuster 30 is secured to first and second longitudinal sides 12, 14 at second end 20. A second width adjuster 32 is attached to first and second longitudinal sides 12, 14 at a mid-point between first end 18 and second end 20. A third width adjuster (not shown) is secured to first and second longitudinal sides 12, 14 at first end 18. Width adjusters include a fastening piece 34 and a receiving piece 36. Fastening piece 34 is threaded through receiving piece 36 and fastening piece 34 can be drawn more or less through receiving piece 36 depending on the desired width of removable tray 10. In this manner, the width at first end 18 can vary from the width at the mid-point and/or the width at second end 20. In one embodiment, the width at first end 18 and second end 20 are smaller than the width at the mid-point in order to fit removable tray 10 to the contours of the mobile apparatus. In this embodiment, varying widths at first end 18 and second end 20 in relation to the mid-point can be achieved by using width adjusters 30, 32 and/or by configuring the shape of removable tray 10 as such.

While FIG. 5 depicts three width adjusters 30, 32 having a Velcro fastening piece 34 that can be threaded through a hard plastic, rectangular loop receiving piece 36, those skilled in the art can appreciate that the number and location of width adjusters 30, 32 can vary and that width adjusters 30, 32 can be configured in various ways in order to secure varying widths. In another embodiment, removable tray 10 does not include width adjusters 30, 32.

In one embodiment removable tray 10 has an open width of about 2 to 4 inches along the top of removable tray 10 and 1 to 2 inches along the bottom of removable tray 10. Those skilled in the art can appreciate that width of the top can vary from width of the bottom or the width can be uniform from top to bottom of removable tray 10.

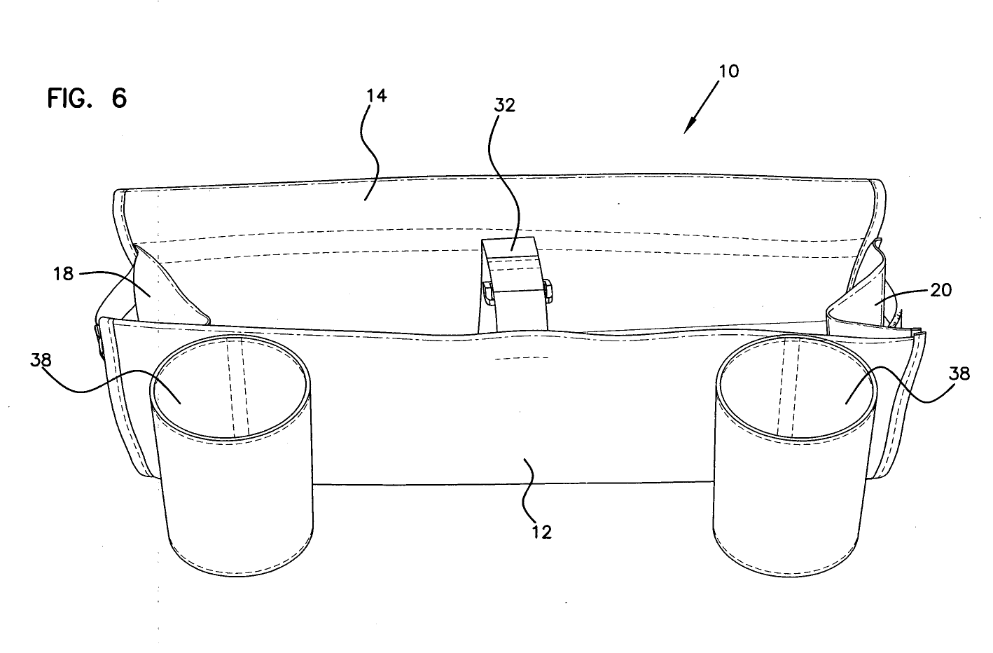

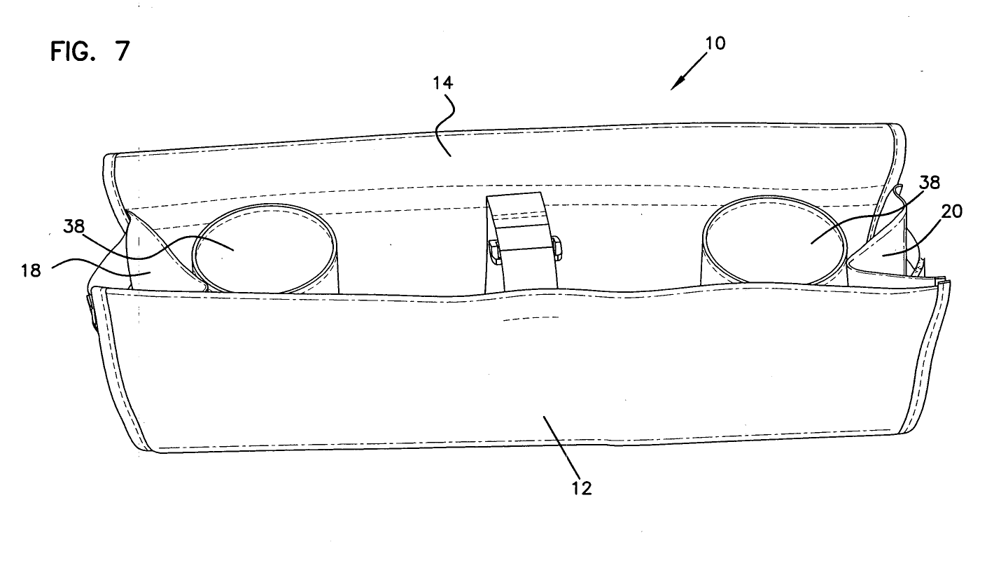

Referring now to FIGS. 6 and 7, in one embodiment, container holders 38 are operably attached to the interior of storage compartment 22. In another embodiment, container holders 38 can be attached to an exterior of removable tray 10. Container holders are sized to hold and support a wide variety of different shaped cups, bottles, glasses and other drinking containers. In one embodiment, container holders 38 are substantially cylindrical in shape. In other embodiments, container holders 38 have different shapes, such as a substantially rectangular shape. Container holders 18 range in size from about 3 inches wide by to about 4 inches wide, about 3 inches deep to about 4 inches deep, and about 4 inches high to about 5 inches high with an open, semi-enclosed or fully enclosed bottom section. The semi-enclosed or enclosed bottom sections are constructed of woven nylon pack or other nylon type fabrics and configured to maintain a beverage container within the container holders. In another embodiment, container holders are about 3.25 inches wide, 3.25 inches deep and about 4.5 inches high with fully enclosed bottoms.

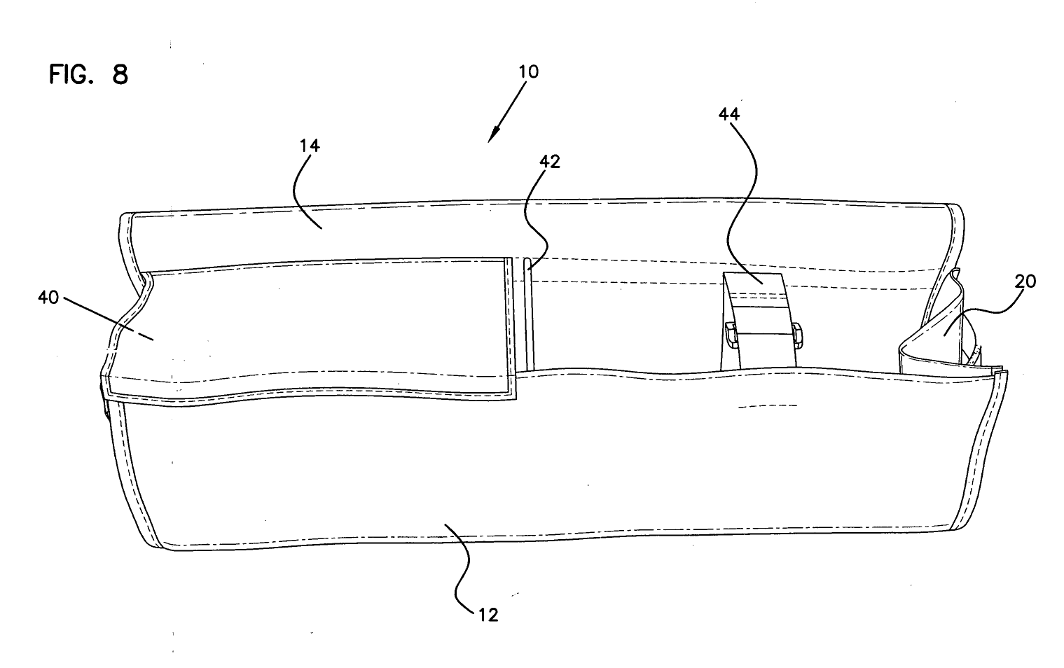

Referring now to FIG. 8, in one embodiment, storage compartment 22 is equipped with additional features, such as lids 40, compartment dividers 44 and removable inserts 42, in order to ensure that items being storage in removable tray 10 are secure. Lids 40 can cover all or only a portion of removable tray 10. Lids 40 can be secured to first longitudinal side 12 via any known fastener, including but not limited to zippers, Velcro, snaps, buttons, ties, hook and eye fasteners, and the like.

Compartment dividers 44 can be permanently attached to first and second longitudinal sides 12, 14 and/or first and second ends 18, 20. Alternately, compartment dividers 44 can be removable attached to first and second longitudinal sides 12, 14 and/or first and second ends 18, 20. Compartment dividers 44 can be connected only along the tops of first and second longitudinal sides 12, 14 and/or first and second ends 18, 20. Alternately, compartment dividers 44 can be continuous pieces with a shape similar to first and second ends 18, 20 and secured within storage compartment 22 along three sides. Compartment dividers 44 can be constructed of woven nylon material, elastic, and the like.

Removable inserts 42 are generally rigid and formed of a hard plastic or other similar material. In one embodiment, removable insert 42 is relatively flat having a shape substantially similar to first end 18 and second end 20. In another embodiment, removable insert 42 is configured as a container having a bottom and four sidewalls extending perpendicular and generally upward from the bottom such that the bottom of removable insert 42 rests on bottom 16 of removable tray 10 and two of the four sidewalls are positioned adjacent first and second longitudinal sides 12, 14.

Now that each component of the present invention has been discussed, following is a discussion of a method of use of removable tray 10 in accordance with the present invention. Referring again to FIG. 3, a user unfolds or unfastens fastening mechanism 24 on second longitudinal side 14 of removable tray 10. The user then aligns second longitudinal side 14 of removable tray 10 with a support on a mobile apparatus and encircles the support with fastening mechanism 24. Fastening mechanism 24 is then fastened thereby securing removable tray 10 to mobile apparatus. In this manner, removable tray 10 is securely attached to the support on the mobile apparatus and hangs via gravity from fastening mechanism 24. In one embodiment, the support is a stroller handle bar. In another embodiment, the support may be any attachment point on the mobile apparatus, including independent handles, support bars, and other hardware attached to the mobile apparatus (i.e., clips, hooks, and the like). In still another embodiment, the support can be at least partially provided by removable tray 10.

Once removable tray 10 is secured to the support, a user may place food and beverage containers, pacifiers, toys, and the like in storage compartment 22. In one embodiment, user can secure containers, toys and the like within container holders that are moveable and/or variable in size to accommodate a wide variety of contents. User can also unfasten attachment mechanism 24 and remove removable tray 10 from mobile apparatus in the event that user wants to secure removable tray 10 to an alternate portion of the same mobile apparatus, secure it to a different mobile apparatus, clean it, fold it up to pack it away, etc.

The invention has herein been described in its preferred embodiments to provide those skilled in the art with the information needed to apply the novel principles and to construct and use the embodiments. However, it is to be understood that the invention can be carried out by specifically different devices and that various modifications can be accomplished without departing from the scope of the invention itself.

What is claimed is:

1. A removable tray comprising:
two opposing longitudinal sides;
first and second ends secured to opposite ends of said longitudinal sides;
a bottom comprising longitudinal surfaces operably connected to lower edges of said longitudinal sides and end surfaces operably connected to first and second ends; and
a fastening mechanism operably attached to an upper edge of one of said longitudinal sides and configured to accommodate attachment of said removable tray to a mobile apparatus.

2. The removable tray of claim 1 further comprising a plurality of width adjusters, said width adjusters placed at varying locations along said longitudinal sides and configured to vary a distance between said opposing longitudinal sides.

3. The removable tray of claim 1 further comprising at least one container holder operably attached to interior surfaces of longitudinal sides and first and second ends.

4. The removable tray of claim 1 further comprising at least one container holder operable attached to exterior surfaces of longitudinal sides and first and second ends.

5. The removable tray of claim 1 further comprising a support configured to be operably connected to at least one support on a mobile apparatus.

6. The removable tray of claim 1 wherein said first and second longitudinal sides are about 8 inches to about 16 inches long and about 2 inches to about 10 inches high.

7. The removable tray of claim 1 wherein said first end and said second end are generally arcuate having a side length of about 2 inches to about 4 inches high and a distance between a flat upper side and an arcuate lower side of about 2 inches to about 5 inches.

8. The removable tray of claim 1 wherein said fastening mechanism is selected from the group consisting of zippers, Velcro, snaps, buttons, ties and hook and eye fasteners.

9. The removable tray of claim 2 wherein said plurality of width adjusters are selected from the group consisting essentially of snaps, buttons, zippers, ties, hook and eye fasteners and Velcro.

10. The removable tray of claim 2 wherein said distance between said opposing longitudinal sides is about 2 inches to about 4 inches along an upper area of said removable tray and about 1 inch to about 2 inches along a lower area of said removable tray.

11. A removable tray comprising:
a continuous piece of a soft material configured to include two opposing longitudinal sides and a bottom;
first and second ends operably attached to opposite ends of said longitudinal sides; and
a fastening mechanism operably attached to an upper edge of one of said longitudinal sides and configured to accommodate attachment of said removable tray to a mobile apparatus.

12. The removable tray of claim 11 further comprising a plurality of width adjusters, said width adjusters placed at varying locations along said longitudinal sides and configured to vary a distance between said opposing longitudinal sides.

13. The removable tray of claim 11 further comprising at least one container holder operably attached to interior surfaces of longitudinal sides and first and second ends.

14. The removable tray of claim 11 further comprising at least one container holder operable attached to exterior surfaces of longitudinal sides and first and second ends.

15. The removable tray of claim 11 further comprising a support configured to be operably connected to at least one support on a mobile apparatus.

16. The removable tray of claim 11 wherein said second longitudinal side is twice as high as said first longitudinal end in order to accommodate said fastening mechanism.

17. The removable tray of claim 11 wherein said continuous piece of soft material is configured to create a generally U-shaped storage compartment.

18. The removable tray of claim 11 wherein said fastening mechanism is selected from the group consisting of zippers, Velcro, snaps, buttons, ties and hook and eye fasteners.

19. The removable tray of claim 12 wherein said plurality of width adjusters are selected from the group consisting essentially of snaps, buttons, zippers, ties, hook and eye fasteners and Velcro.

20. The removable tray of claim 2 wherein said distance between said opposing longitudinal sides is about 2 inches to about 4 inches along an upper area of said removable tray and about 1 inch to about 2 inches along a lower area of said removable tray.
